(19) United States
(12) Patent Application Publication
(10) Pub. No.: US 2005/0279768 A1
(43) Pub. Date: Dec. 22, 2005

(54) Method and apparatus for dispensing a filtered liquid

(76) Inventor: Mon Chatrath, Newark, CA (US)

Correspondence Address: LAHIVE & COCKFIELD, LLP., 28 STATE STREET, BOSTON, MA, 02109, US

(21) Appl. No.: 11/072,109

(22) Filed: Mar. 3, 2005

Related U.S. Application Data
(60) Provisional application No. 60/550,239, filed on Mar. 3, 2004.
(60) Provisional application No. 60/627,789, filed on Nov. 12, 2004.

(51) Int. Cl. B67D 5/58

(52) U.S. Cl. 222/189.06

(57) ABSTRACT

A hand-held liquid dispensing apparatus for dispensing a filtered liquid includes a dispenser body defining a reservoir for holding a liquid to be dispensed, a cap assembly including a spout through which liquid is dispensed from the dispenser body, and a filter assembly disposed in the dispenser body and secured to the cap assembly. The filter assembly defines a liquid dispensing flow path extending between the reservoir and the spout and along which liquid flows when being dispensed from the reservoir. The liquid dispensing flow path includes a microporous filtration element having a pore size of about 0.3 microns for effectively removing particulate having a size of 0.3 microns or larger from the liquid being dispensed.

### PRIORITY CLAIM

This application claims the benefit, under 35 USC 119(e), of U.S. Provisional Application Nos. 60/550,239 and 60/627,789, which were filed on Mar. 3, 2004 and Nov. 12, 2004, respectively. The entire contents of each of the U.S. Provisional Application Nos. 60/550,239 and 60/627,789 are hereby incorporated by reference.

### FIELD OF THE INVENTION

This invention relates to liquid purification and more specifically to a method and apparatus for storing and dispensing a purified liquid from a portable hand-held beverage container such as, for example, water bottles and the like.

### BACKGROUND OF THE INVENTION

Providing a personal drinking container that filters liquid contents as they are dispensed can be advantageous in many situations. A user can simply fill or refill the container with liquid from a supply such as a tap, fountain, etc, and be at ease that when dispensed from the container, the liquid will be safe to drink.

U.S. Pat. No. 5,609,759 and continuation U.S. Pat. No. 6,161,362 teach a bottle filter cap having a filtering element that includes activated carbon and has a porosity of about 10-120 microns.

U.S. Pat. No. 6,395,170 discloses a water filter adapted to fit into a bottle neck, and having a filter matrix with a median pore size of about 30-60 microns. This patent further teaches that such a tight pore size is made possible by providing an air return path controlled by an umbrella valve for permitting entry of air after the bottle has been squeezed.

### SUMMARY OF THE INVENTION

The present invention provides a liquid dispensing apparatus having a reservoir that can be filled with a liquid, and that filters and/or purifies the liquid as it is dispensed from the reservoir. In some embodiments, the liquid is filtered to remove impurities having a size as small as 0.3 microns. In other embodiments, the dispensed liquid is filtered to remove impurities having a size as small as 0.01 microns. The dispensed liquid can also, in some embodiments, be treated with a microbicide to sterilize and further purify the liquid. The dispensing apparatus generally provides a dispensing liquid flow path in which liquid is directed through various filtration elements as the liquid is dispensed. The apparatus can further provide a fluid intake flow path that bypasses some or all of the filtration elements to admit a pressure-equalizing fluid to enter the reservoir after liquid has been dispensed.

According to one aspect of the present invention, a hand-held liquid dispensing apparatus for dispensing a filtered liquid is provided. The dispensing apparatus includes a dispenser body defining a reservoir for holding a liquid to be dispensed, a cap assembly including a spout through which liquid is dispensed from the dispenser body, and a filter assembly disposed in the dispenser body and secured to the cap assembly. The filter assembly defines a liquid dispensing flow path extending between the reservoir and the spout and along which liquid flows when being dispensed from the reservoir. The liquid dispensing flow path includes a microporous filtration element having a pore size of about 0.3 microns for effectively removing particulate having a size of 0.3 microns or larger from the liquid being dispensed.

The microporous filtration element can be generally cylindrical, having porous sidewalls, the porous sidewalls defining an interior chamber, the interior chamber comprising a portion of the fluid dispensing flow path downstream of the microporous filtration element. The microporous filtration element can obtain roasted coconut shell activated carbon.

The liquid dispensing apparatus can also be provided with a filtering screen disposed in the flow path upstream of the microporous element for removing larger particulate from the liquid being dispensed in advance of the microporous element. The filtering screen can include a mesh having flow apertures of about 0.1 mm×0.1 mm to about 2.0 mm×2.0 mm in size.

The dispenser body can be of a resilient, flexible material adapted to be squeezed to dispense liquid through the spout. The apparatus can include an intake valve assembly for drawing fluid back into the reservoir after liquid has been dispensed. The intake valve can include a valve inlet for receiving fluid from the chamber, and a valve outlet for discharging fluid to the reservoir, the intake valve providing a fluid intake flow path from the chamber to the reservoir that bypasses the microporous filtration element.

The apparatus can further be provided with a hollow fiber filtration cartridge having hollow fibers with porous sidewalls and disposed in the liquid dispensing flow path, the porous sidewalls having an upstream side for receiving liquid that has passed through the microporous filtration element, and a downstream side for discharging liquid towards the spout. The hollow fiber filtration cartridge can be disposed in the chamber.

The apparatus can further be provided with a disinfectant module disposed in the liquid dispensing flow stream, between the hollow fiber module and the spout. The disinfectant module can include a microbicide for treating the liquid being dispensed as it flows through the disinfectant module.

### BRIEF DESCRIPTION OF THE DRAWINGS

For a better understanding of the present invention and to show more clearly how it would be carried into effect, reference will now be made by way of example, to the accompanying drawings that show a preferred embodiment of the present invention, and in which:

FIG. 1 is an elevation view in cross-section of a dispenser apparatus in accordance with one embodiment of the present invention;

FIG. 2 is an exploded view showing a cap assembly portion of the apparatus of FIG. 1 in greater detail;

FIG. 3 is an exploded view showing a filter assembly portion of the apparatus of FIG. 1 in greater detail;

FIG. 4 is an enlarged elevation view in cross-section showing an intake valve assembly portion of the apparatus of FIG. 1 in greater detail;

FIGS. 5 and 6 are enlarged views of a portion of FIG. 4 showing a closure member of the intake valve assembly in closed and open positions, respectively;

FIG. 7 is a perspective view showing a retainer element of the intake valve assembly of FIG. 4 in greater detail;

FIG. 8 is an elevation view in cross-section of another embodiment of a dispenser apparatus of the present invention;

FIG. 9 is a perspective view showing a hollow fiber filtration cartridge of the apparatus of FIG. 8 in more detail; and,

FIG. 10 is an exploded view in cross-section showing a disinfectant module of the apparatus of FIG. 8 in more detail.

### DETAILED DESCRIPTION OF THE INVENTION

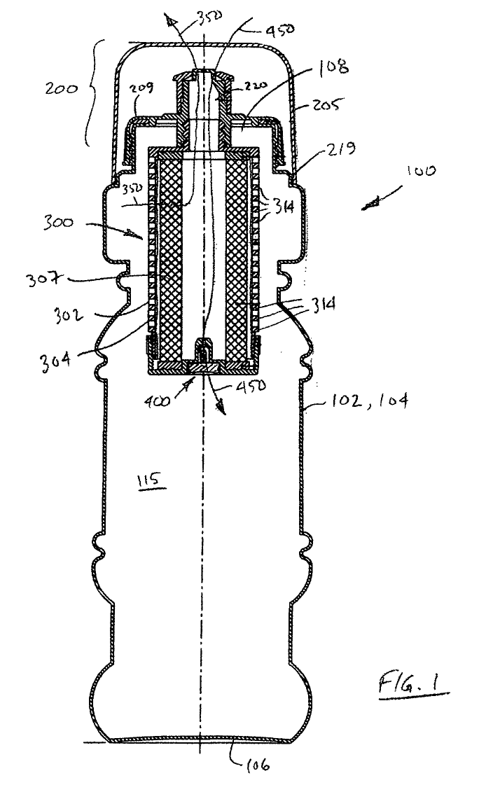

A dispenser 100 in accordance with the present invention can be seen in FIG. 1. The dispenser 100 is adapted to provide a portable supply of water or other liquid for drinking purposes.

The dispenser 100, in the embodiment illustrated, includes a dispenser body 102, a cap assembly 200, a decontamination assembly 300 (also called a filter assembly 300) and an intake valve assembly 400.

The dispenser body 102 provides a container for holding the liquid. In the embodiment illustrated, the dispenser body 102 is generally cylindrical, having a cylindrical sidewall portion 104, a closed lower end 106, and a generally open upper end or mouth 108. The dispenser body 102 can be constructed of a suitable material, such as a polymer material.

The size of the body 102 can be adapted to be conveniently held in the hand of a user. The body 102 can be flexibly resilient so that a user can squeeze the sidewall 104 to force liquid contents out through the mouth 108 of the body 102, the body 102 generally returning to its original shape after being squeezed. The mouth 108 of the body 102 is adapted to receive the cap assembly 200 for releasably closing the mouth 108. The body 102 is also adapted to receive the filter assembly 300, as discussed in greater detail subsequently herein. The volume defined by the space within the body 102 but outside the filter assembly 300 generally defines a reservoir area 115 of the body 102.

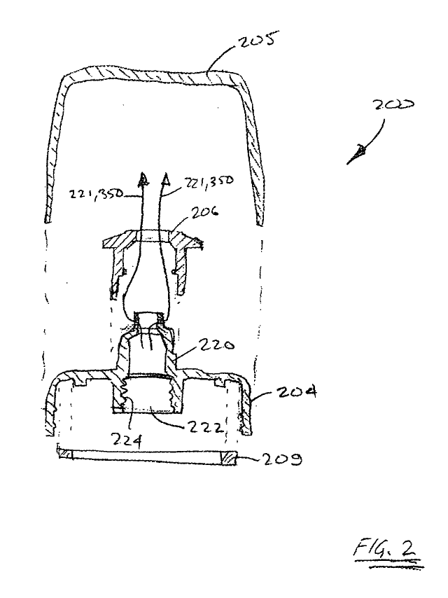

As best seen in FIG. 2, the cap assembly 200 includes a lid 204 that can be screwed, snap-fit, or otherwise assembled to the body 102 so that the lid 204 generally covers the mouth 108 of the body 102 (see also FIG. 1). A gasket 209 can be provided between the lid 204 and the body 102 for providing a liquid-tight seal therebetween.

The lid 204 is provided with an aperture for dispensing liquid. In the embodiment illustrated, the aperture includes a generally cylindrical spout 220 extending upward (opposite the body 102) from the lid 204.

The spout 220 is adapted to receive a push/pull spout plug 206 for alternately sealing or opening flow channel 221 through the spout 220. The spout plug 206 can be adapted to be slidably retained on the spout 220, movable between closed (pushed down) and open (pulled up) positions.

The cap assembly 200, in the illustrated embodiment, is further provided with a cup-shaped cover 205 that can be releasably secured to the dispenser 100 in an inverted position. The cup-shaped cover 205 can protect the spout 220 and spout plug 206 from becoming contaminated with dirt or the like, and can also provide a convenient tumbler that can be filled for drinking, rather than squirting liquid directly from the spout 220 into one's mouth. In the embodiment illustrated, the cup-shaped cover 205 is releasably secured to the dispenser 100 by means of a press fit between the inner diameter of the cover 205 and the outer diameter of a shoulder 219 provided adjacent the upper end of the body 102, as best seen in FIG. 1.

The cap assembly 200, in the illustrated embodiment, is also provided with a filter port 222 that depends from the underside surface of the lid 204, opposite the spout 220. Any liquid dispensed from the body 102 (when in use) is directed to flow through the filter port 222 and the spout 220.

The port 222 can be adapted to have the filter assembly 300 attached thereto (as will be further described subsequently). In the embodiment illustrated, the port 222 is provided with internal threads 224 for such attachment.

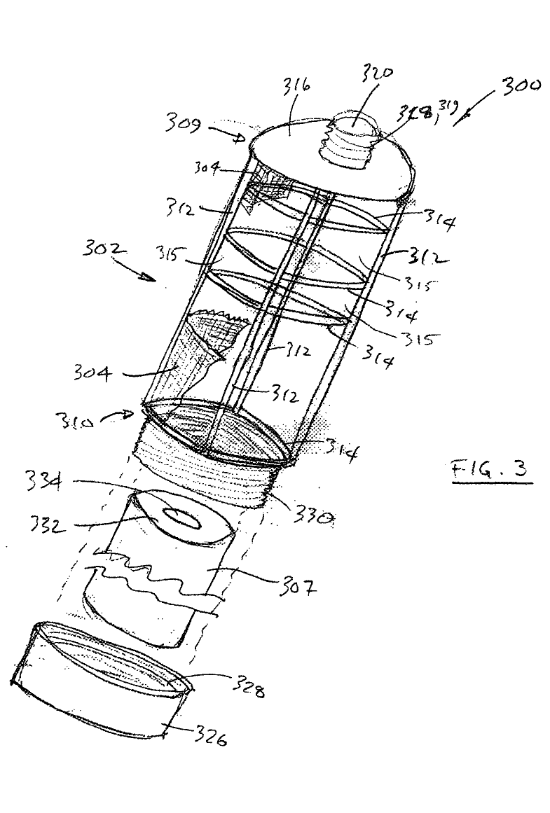

Referring again to FIG. 1, the filter assembly 300 in the illustrated embodiment includes a filter housing 302, with a filtering screen 304 and a microporous filtration element 307 disposed within the filter housing 302. As best seen in FIG. 3, the filter housing 302 can be constructed in the form of a generally cylindrically shaped cage, having an upper end 309 and lower end 310. The housing 302 is provided with a plurality of longitudinal members 312 spaced around the perimeter of the housing 302, and each extending between the upper and lower ends 309, 310, and a plurality of hoop members 314 spaced in generally parallel relation between and along the lengths of the longitudinal members 312. The network of interconnecting longitudinal members 312 and hoop members 314 provides structural support for the housing 302, and defines windows 315 for fluid communication from the reservoir area 115 to the interior of the housing 302. In the embodiment illustrated, only four hoop elements 314 are illustrated, but generally more hoop members 314 would be provided, as indicated for example in FIG. 1.

The housing 302 is, in the embodiment illustrated, further provided with an upper panel 316 in the form of a disc that covers the upper end 309 of the housing 302. Attachment means 318 is provided on the upper surface of the upper panel 316 for securing the housing 302 to the dispenser 100. In the embodiment illustrated, the attachment means 318 is in the form of an externally threaded boss 319 that is adapted to engage the internal threads 224 of the port 222 of the cap assembly 200. The boss 319 is provided with an axial through-hole 320 to provide fluid communication between the port 222 and the interior space of the filter housing 302.

The lower end 310 of the housing 302 can be closed off by a base 326. The base 326 can be generally U-shaped in cross-section, and can have internally threaded sidewalls 328 for engaging an externally threaded collar 330 depending from the lower end 310 of the housing 302.

The housing 302 and base 326 can be constructed of any suitable material such as polymer material, and can be formed by injection moulding or any other suitable process.

The filtering screen 304 can be arranged in a generally cylindrical configuration within the housing 302, such that it lines the cylindrical envelope formed by the housing 302. The filtering screen 304 can be positioned so that any fluid flow from the space outside the housing 302 (i.e. the reservoir 115) to the interior of the housing 302 must pass through the filtering screen 304. The filtering screen can be constructed of a polymer mesh, having intersecting strands forming filtration apertures therebetween. The apertures of the filtering screen 304 can be generally square, having dimensions of about 0.1 mm×0.1 mm or smaller to about 2 mm×2 mm or larger.

The microporous filtration element 307 is generally cylindrical in shape, having an outer diameter less than the inner diameter of the cylindrical filtering screen 314, and a height that extends between the upper and lower ends 309, 310 of the housing 302. The microporous filtration element 307 can have relatively thick but porous sidewalls 332. The interior of the microporous filtration element 307 defines a chamber 334. Any liquid entering the chamber 334 first passes through the porous sidewalls 332.

The microporous filtration element 307 can be constructed of an activated carbon material. The inventors have discovered that a particularly advantageous activated carbon material is roasted coconut shell activated carbon. The roasted coconut shell activated carbon has a plurality of interconnected micropores of a size of about 0.3 microns, and has been found to effectively filter particulate having a size (diameter) as small as 0.3 microns.

To use the dispenser 100, the cap assembly 200 is removed from the body 102 (along with the attached filter assembly 300) and the body 102 is filled with a desired liquid drink. The cap assembly 200 (with the attached filter assembly 300) is then reattached to the body 102.

To dispense the liquid, the body 102 can be squeezed by a user's hand. This pressure forces liquid through the filtering screen 304, then through the porous sidewalls 332 of the microporous filtration element 307 and into the chamber 334. From the chamber 334, the liquid is forced through the aperture 320 in the upper panel 316 of the filter housing 302, through the port 222 and then out of the spout 220. This flow of liquid from the reservoir area 115 out through the spout 220 defines a liquid dispensing flow path 350 (FIGS. 1 and 2).

Once the pressure squeezing the body 102 of the dispenser 100 is released, the resilient body 102 exerts a force tending to restore the body 102 to its original shape. In returning to its original shape, the dispenser 100 will generally draw fluid (including air) into the body 102, to replace the volume of liquid and/or air previously dispensed. The inventors have found that the time required for drawing fluid back into the container can be undesirably long, particularly where the fluid must flow (in reverse direction) through the same path as the dispensed liquid, and particularly where that path includes reverse air flow through the porous sidewalls 332 of the microporous filtration element 307. Too long a time for fluid intake can be annoying to a user who wishes to dispense liquid a second time after an initial dispensing.

To facilitate drawing intake fluid into the body 102 after a liquid dispensing cycle, the dispenser 100 can be provided with a fluid intake valve assembly 400 (see also FIG. 4). The fluid intake valve assembly 400 in the embodiment illustrated provides a fluid intake flow path 450 for drawing fluid from outside the dispenser 100 (and/or from the chamber 334) into the liquid reservoir area 115 of the body 102 that is different than the liquid dispensing flow path 350 (FIG. 1), and in particular, that bypasses the microporous filtration element 307.

Referring now to FIGS. 4, 5, and 6, the fluid intake valve assembly 400 can be provided in the base 326 of the filter assembly 300. In the embodiment illustrated, the fluid intake valve assembly 400 includes a valve pocket or seat 402 and a retainer seat 404 provided in the base 326 of the filter assembly 300. The base 326 has an upwardly protruding boss 406, and the valve seat 402 and retainer seat 404 are provided in upper and lower portions of the boss 406. In the embodiment illustrated, the valve seat 402 is generally dome shaped, having cylindrical sidewalls and a curved, upper seal surface 405. The retainer seat 404 is generally in the form of an annular counter bore, having an outer diameter greater than the outer diameter of the sidewalls of the valve seat 402. The boss 406 is generally centrally located with respect to the base 326, and can protrude into the chamber 334 of the microporous filtration element 307. An intake orifice 408 is provided through an upper wall of the boss 406, proximate the seal surface 405, to facilitate fluid intake flow from the chamber 334 to the reservoir area 115 of the body 102. The intake orifice 408 provides a valve inlet 409 for the valve assembly 400.

The intake valve assembly 400 in the illustrated embodiment further comprises a closure member 412 and a retainer 414 positioned in the respective seats 402 and 404. The closure member 412 is, in the embodiment illustrated, a plug element that is generally cylindrical and can be bullet shaped, having a cylindrical body portion 414 and a curved head portion 416. The curved head portion 416 can be adapted to engage the concave seal surface 405 of the valve seat 402 in sealed contact to prevent fluid flow in a direction from the reservoir area 115 of the body 102 into the chamber 334 of the microporous filtration element 307. The closure member 412 can be constructed of a resiliently deformable material, such as, for example, but not limited to, a rubber material having a hardness of about 65 Shore A.

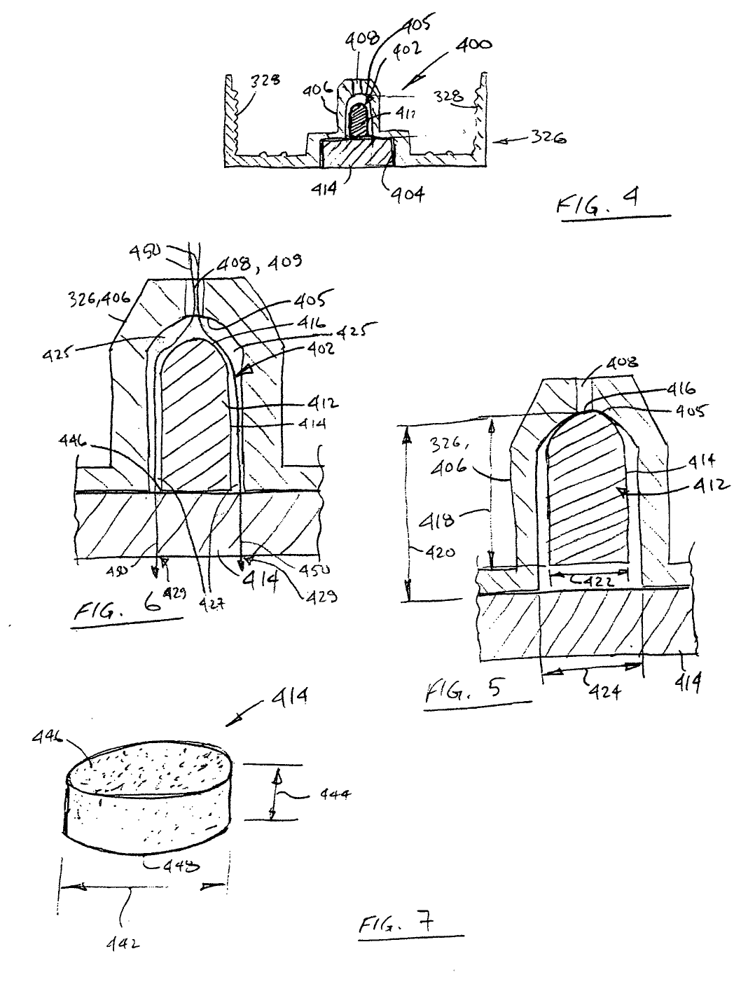

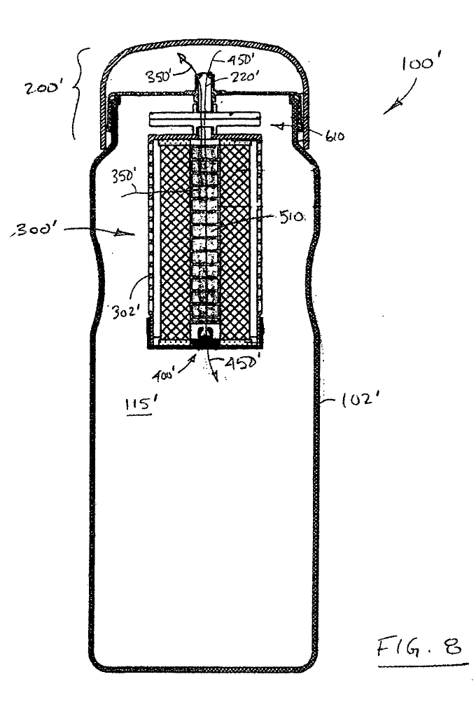

The closure member 412 is moveable between open and closed positions. In the closed position (FIG. 5), the head portion 416 of the closure member 412 is in sealed engagement with the seal surface 405. In the open position (FIG. 6), the closure member 412 is clear of the seal surface 405 and fluid flow from the chamber 334 to the reservoir area 115 is permitted. To facilitate movement between the open and closed positions, the closure member 412 in the embodiment illustrated has an axial extent 418 that is less than the axial extent 420 of the valve seat 402, and a diameter 422 that is less than the diameter 424 of the valve seat 402. The smaller size of the closure member 412 relative to the valve pocket (seat) 402 provides a gap 425 between the outer surface of closure member 412 and the surface of the valve seat 402 when in the open position (FIG. 6). The gap 425 provides a flow channel through which the intake flow path 450 extends.

The axial extent 418 of the closure member 412 can be sized greater than the diameter 424 of the valve seat 402 to inhibit inversion or improper alignment of the closure member 412 within the valve seat 402.

Referring now also to FIG. 7, the retainer 414 is adapted to retain the closure member 412 in the valve seat 402. The retainer can also be adapted to facilitate fluid flow between the orifice 408 and the reservoir area 115 of the body 102. The retainer 414 can have one or more apertures, pores, or the like to facilitate fluid flow from a lower end 427 of the gap 425 to the reservoir area 115. The point along the intake fluid path 450 at which the fluid enters the reservoir area 115 (e.g. is clear of the retainer 414) generally defines a valve outlet 429 of the valve assembly 400. In the embodiment illustrated, the retainer 414 is generally disc-shaped, having a diameter 442, an axial height 444, and an upper face 446 and a lower face 448. The retainer 414 is adapted to be press-fit into the retainer seat 404 of the base 326. The closure member 412 can bear against the upper surface 446 of the retainer 414 when in the open position (FIG. 6) to keep the closure member 412 in the valve pocket 402.

The retainer 414 is further, in the embodiment illustrated, made of a porous material so that fluid can flow between the upper and lower faces 446, 448 of the retainer 414. The porosity of the retainer 414 is greater than that of the porous sidewalls 332 of the microporous filtration element 307. For example, the retainer 414 can be constructed of sintered polypropylene providing an average pore size of about 70 microns. This is more than 20 times greater than the porosity of the porous sidewalls 332, which in one embodiment has a pore size of about 0.3 microns. The increased porosity can provide a relatively low pressure gradient across the thickness of the retainer 414, which can provide a correspondingly lower resistance to fluid flow, providing certain advantages as will be described subsequently. The retainer 414 may be of any suitable alternate construction, including, for example, providing a disc of generally non-porous material with apertures to provide “pores” for fluid flow between the lower ends 427 of the gap 425 and the valve outlet 429.

In operation, squeezing of the dispenser 100 by a user will force liquid through the porous retainer, which will then bear against the closure member 412 and move the closure member 412 to the closed position. Further pressure will only cause the closure member to seal more tightly against the seal surface. The only flow path for the liquid to flow from the reservoir area 115 to the spout 220 is through the filter assembly 300, as described previously.

When the force squeezing the dispenser 100 is released, the body 102 will attempt to regain its original shape. The expanding body 102 will create a vacuum effect (or negative pressure) in the body 102, which will attempt to draw fluid (i.e. liquid remaining in the chamber 334 and air from the environment outside the dispenser 100) back into the body 102. The suction will act to urge some intake fluid back through the liquid dispensing flow path (i.e. through the microporous filtration element 307 and the filtering screen 304). This may draw only a small amount of intake fluid per unit time, however, since the small pore size of the microporous filtration element 307 can present significant resistance to fluid flow, and since the force creating the suction is generated primarily by the resiliency of the body 102 attempting to regain its original shape, which will generally be a significantly lower force than can be applied by a user when forcing liquid out of the dispenser 100.

The fluid intake assembly 400 can help to overcome these problems by providing the fluid intake path 450, since the suction will also act on the closure member 412 and can move the closure member 412 to the open position. When in the open position, a fluid alternate intake flow path is provided for drawing the intake fluid into the reservoir area 115 of the body 102. In particular, in the embodiment illustrated, intake fluid can flow from the chamber 334 of the microporous filtration element 307, through the intake orifice 408, through the gap 425 provided between the closure member 412 and the valve seat 402, through the porous retainer 414, and then into the reservoir area 115 of the body 102. The intake fluid path 450 bypasses the porous sidewalls 332 of the microporous filtration element 307, thus providing a flow path 450 with considerably less resistance and allowing intake fluid to make its way into the reservoir area 115 much more quickly than if the intake fluid were drawn in along a reverse direction through the liquid dispensing flow path 350.

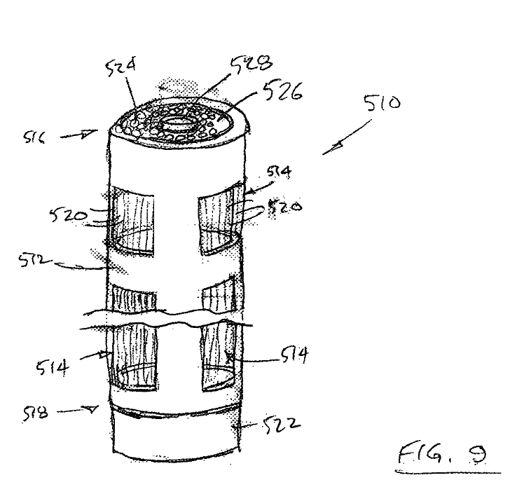

Referring now to FIGS. 8-10, another embodiment of a liquid dispenser 100′ is shown. The dispenser 100′ is similar to the dispenser 100, and like features are identified by like reference characters with the addition of a prime (′) suffix.

The dispenser 100′ is provided with a filter assembly 300′ having a housing 302′, a filtering screen 304′, and a microporous filtration element 307′. The filter assembly 300′ is further provided with a hollow fiber filter cartridge 510. The hollow fiber filter cartridge 510 is, in the embodiment illustrated, generally cylindrical in shape and is disposed within the chamber 334′ defined by the interior of the microporous filtration element 307′.

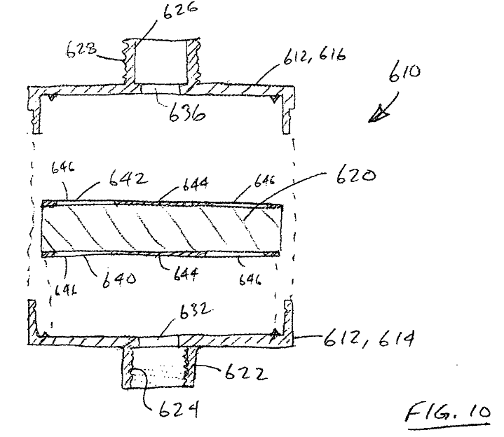

As best seen in FIG. 9, the hollow fiber cartridge 510 in the illustrated embodiment has a generally cylindrical shell 512 with liquid flow windows 514 in the sides of the shell 512. The shell 512 has an upper end 516 and lower end 518, and a plurality of hollow fibers 520 in the shell 512 and each extending generally between the upper and lower ends 516 and 518. The hollow fibers can be in the form of slender tubes having porous sidewalls with a pore size in the range of about 0.01 microns. Passage of liquid through the sidewalls can further secure molecular impurities, bacteria, and viruses.

The hollow fiber cartridge 510 can further be provided with a base 522 to which the lower ends 518 of the fibers 520 are secured such that the hollow centers or lumens 524 of the fibers are sealed off against liquid entry.

The cartridge 510 can further be provided with an upper support disc 526 that seals against any liquid flow from beneath the disc 526, except for flow through the lumens 524 of the fibers 520, the upper ends 516 of the fibers 520 extending through the disc 526 and being open above the disc 526.

The cartridge 510 can further be provided with a central intake duct 528 in the form of a cylindrical tube extending the height of the cartridge 510.

In use, when the dispenser 100′ is squeezed, liquid is forced along a liquid dispensing flow path 350′ that includes flow through the filtering screen 304′ (first stage filtration) and the microporous filtration element 307′ (second stage filtration) as explained with respect to the dispenser 100. Further, liquid is then forced through the porous sidewalls of the fibers 520, and out through the exposed upper ends of the lumens 524. This provides a third stage of filtration. The liquid can then flow out through the axial hole 320′ for dispensing from the dispenser 100′.

The sidewalls of the fibers 520 can act as membranes through which the liquid passes. In the embodiment illustrated, the interior surface of the sidewalls (defining the lumens 524) is on the downstream side of the liquid dispensing flow path 350′, and the exterior surface of the sidewalls (opposite the interior surface) is on the upstream side of the liquid dispensing flow path 350′. The hollow fibers 520 are downstream of the microporous filtration element 307′, and removal of particulate in the liquid by the microporous filtration element 307′ in advance of the hollow fibers 520 can protect the fibers 520 and prolong the useful life of the fibers 520.

When a user releases the squeezing force on the body 102′ of the dispenser 100′, a suction effect is generated, tending to draw intake fluid into the reservoir area 115′ of the dispenser 100′. The intake duct 528 provides a portion of the fluid intake flow path 450′ so that the intake fluid need not pass through the walls of the fibers 520, nor the walls of the microporous filtration element 307′, but rather bypasses these elements to facilitate speedy fluid intake into the reservoir 115′.

Referring now to FIGS. 8 and 10, the dispenser 100′ can further be provided with a disinfectant module 610. The disinfectant module 610 is, in the illustrated embodiment, positioned between the housing 302′ of the filter assembly 300′ and the spout 220′ of the dispenser 100′.

The disinfectant module 610 has a casing 612, which can include a lower shell 614 and an upper shell 616 that can be assembled to define a generally enclosed treatment cell 618. A disinfecting resin 620 is provided in the treatment cell 618. The resin can include a microbicide such as, for example, but not limited to, a polyiodide resin that can disinfect and sterilize liquid upon exposure to the resin.

The casing 612 can be provided with a lower boss 622 depending from the lower shell 614 and having internal threads 624 for assembly with the externally threaded boss 319′ of the filter housing 302′. The casing 612 can further be provided with an upper boss 626 depending from the upper shell 616 and having external threads for assembly with the internal threads 224′ of the port 222′ of the cap assembly 200′. The lower and upper bosses, 622, 626 can have internal bores 632, 636 respectively to provide flow communication between the filter housing 302′ and the spout 220′.

In operation, liquid being dispensed can flow from the through-hole 320′ of the filter housing 302′ (after having passed through, for example, the first, second, and third filtration stage as described previously), and into the disinfectant module 610 via the lower bore 632. Within the casing 612, the liquid is exposed to the resin 620 upon which the liquid is disinfected and sterilized. The liquid can then flow towards the spout 220′ by exiting the casing 612 via the upper bore 636.

To promote a high level of contact between the resin 620 and liquid being dispensed, the disinfectant module 610 can be provided with one or both of lower and upper flow dispersion plates 640, 642. The dispersion plates 640, 642 can be relatively thin discs that sandwich the resin 620. The plates 640, 642 can have generally solid radially central zones 644 to inhibit direct axial flow between the lower and upper bores 632, 636. The plates 640, 642 can have open radially outward zones 646 to permit flow across the resin 620.

The disinfectant module 610 generally provides an optional fourth stage of liquid filtration. The term liquid filtration is used herein to denote any treatment of liquid for removing impurities or for disinfecting or otherwise purifying a liquid. The disinfectant module 610 generally does not remove any solids or particulate from the liquid, but it can further purify the liquid being dispensed. The disinfectant module 610 creates a negligible pressure drop between the lower and upper bores 632, 636, and so special provision for providing a separate intake flow path generally need not be provided.

The dispenser 100, 100′ of the present invention can provide a dispenser that is easily carried by a user, is easy to use, and provides a high degree of filtration. The degree of filtration provided can include removal of impurities having a size as small as 0.3 microns or 0.01 microns, and treatment by a microbicide to disinfect or sterilize the liquid.

The dispenser components can be relatively easily and cost-effectively manufactured. The dispenser can be easily disassembled for cleaning or replacement of the various components.

While preferred embodiments of the invention have been described herein in detail, it is to be understood that this description is by way of example only, and is not intended to be limiting. The full scope of the invention is to be determined from reference to the appended claims.

1. A hand-held liquid dispensing apparatus for dispensing a filtered liquid, the apparatus comprising:
(a) a dispenser body defining a reservoir for holding a liquid to be dispensed;
(b) a cap assembly including a spout through which liquid is dispensed from the dispenser body; and,
(c) a filter assembly disposed in the dispenser body and secured to the cap assembly, the filter assembly defining a liquid dispensing flow path extending between the reservoir and the spout and along which liquid flows when being dispensed from the reservoir,
the filter assembly liquid dispensing flow path including a microporous filtration element disposed in the liquid dispensing flow path having a pore size of about 0.3 microns for effectively removing particulate having a size of 0.3 microns or larger from the liquid being dispensed.

2. The apparatus of claim 1 wherein the microporous filtration element comprises roasted coconut shell activated carbon.

3. The apparatus of claim 1 further comprising a filtering screen disposed in the flow path upstream of the microporous element for removing coarse particulate from the liquid being dispensed in advance of the microporous element.

4. The apparatus of claim 3 wherein the filtering screen comprises a mesh having flow apertures of about 0.1 mm×0.1 mm to about 2.0 mm×2.0 mm in size.

5. The apparatus of claim 3 wherein the dispenser body is a resilient, flexible material and adapted to be squeezed to dispense liquid through the spout.

6. The apparatus of claim 5 further comprising an intake valve assembly for drawing fluid back into the reservoir after liquid has been dispensed.

7. The apparatus according to claim 6 wherein the microporous filtration element is generally cylindrical, having porous sidewalls, the porous sidewalls defining an interior chamber, the interior chamber comprising a portion of the fluid dispensing flow path downstream of the microporous filtration element.

8. The apparatus according to claim 7 wherein the intake valve has a valve inlet receiving fluid from the chamber, and a valve outlet discharging fluid to the reservoir, the intake valve providing a fluid intake flow path from the chamber to the reservoir that bypasses the microporous filtration element.

9. The apparatus according to claim 6 further comprising a hollow fiber filtration cartridge having hollow fibers with porous sidewalls and disposed in the liquid dispensing flow path, the porous sidewalls having an upstream side for receiving liquid that has passed through the microporous filtration element, and a downstream side for discharging liquid towards the spout.

10. The apparatus according to claim 9 wherein the hollow fiber filtration cartridge is disposed in the chamber.

11. The apparatus according to claim 9 further comprising a disinfectant module provided in the liquid dispensing flow stream, between the hollow fiber module and the spout.

12. The apparatus according to claim 11 wherein the disinfectant module includes a microbicide for treating the liquid being dispensed as it flows through the disinfectant module.
